(19) United States
(12) Patent Application Publication
(10) Pub. No.: US 2013/0276029 A1
(43) Pub. Date: Oct. 17, 2013

(54) Using Gestures to Capture Multimedia Clips

(71) Applicants: Wenlong Li, Beijing (CN); Dayong Ding, Beijing (CN); Xiaofeng Tong, Beijing (CN); Yangzhou Du, Beijing (CN); Peng Wang, Beijing (CN)

(72) Inventors: Wenlong Li, Beijing (CN); Dayong Ding, Beijing (CN); Xiaofeng Tong, Beijing (CN); Yangzhou Du, Beijing (CN); Peng Wang, Beijing (CN)

(21) Appl. No.: 13/994,764

(22) PCT Filed: Sep. 12, 2011
(86) PCT No.: PCT/CN2011/001548

§ 371 Date: Jun. 17, 2013

(51) Int. Cl. H04N 21/482

(52) U.S. Cl. CPC H04N 21/482
USPC 725/38

(57) ABSTRACT

In response to a gestural command, a video currently being watched can be identified by extracting at least one decoded frame from a television transmission. The frame can be transmitted to a separate mobile device for requesting an image search and for receiving the search results. The search results can be used to obtain more information. The user's social networking friends can also be contacted to obtain more information about the clip.

### BACKGROUND

This relates generally to video, including broadcast and streaming television, movies and interactive games.

Television may be distributed by broadcasting television programs using radio frequency transmissions of analog or digital signals. In addition, television programs may be distributed over cable and satellite systems. Finally, television may be distributed over the Internet using streaming. As used herein, the term “television transmission” includes all of these modalities of television distribution. As used herein, “television” means the distribution of program content, either with or without commercials and includes both conventional television programs, as well as the distribution of video games.

Systems are known for determining what programs users are watching. For example, the IntoNow service records, on a cell phone, audio signals from television programs being watched, analyzes those signals, and uses that information to determine what programs viewers are watching. One problem with audio analysis is that it is subject to degradation from ambient noise. Of course, ambient noise in the viewing environment is common and, thus, audio based systems are subject to considerable limitations.

### BRIEF DESCRIPTION OF THE DRAWINGS

FIG. 1 is a high level architectural depiction of one embodiment of the present invention;

FIG. 2 is a block diagram of a set top box according to one embodiment of the present invention;

FIG. 3 is a flow chart for a multimedia grabber in accordance with one embodiment of the present invention;

FIG. 4 is a flow chart for a mobile grabber in accordance with one embodiment of the present invention;

FIG. 5 is a flow chart for a cloud based system for performing image searching in accordance with one embodiment of the present invention; and

FIG. 6 is a flow chart for a sequence for maintaining a table according to one embodiment.

### DETAILED DESCRIPTION

In accordance with some embodiments, a multimedia clip, such as a limited duration electronic representation of a video frame or clip, metadata or audio, may be grabbed from the actively tuned television transmission currently being watched by one or more viewers. A hand gesture may be recognized to select a currently played multimedia clip for searching. This multimedia clip may then be transmitted to a mobile device in one embodiment. The mobile device may then transmit the information to a server for searching. For example, image searching may ultimately be used to determine who the actors are in a video. Once the content is identified, then it is possible to provide the viewer with a variety of other services. These services can include the provision of additional content, including additional focused advertising content, social networking services, and program viewing recommendations.

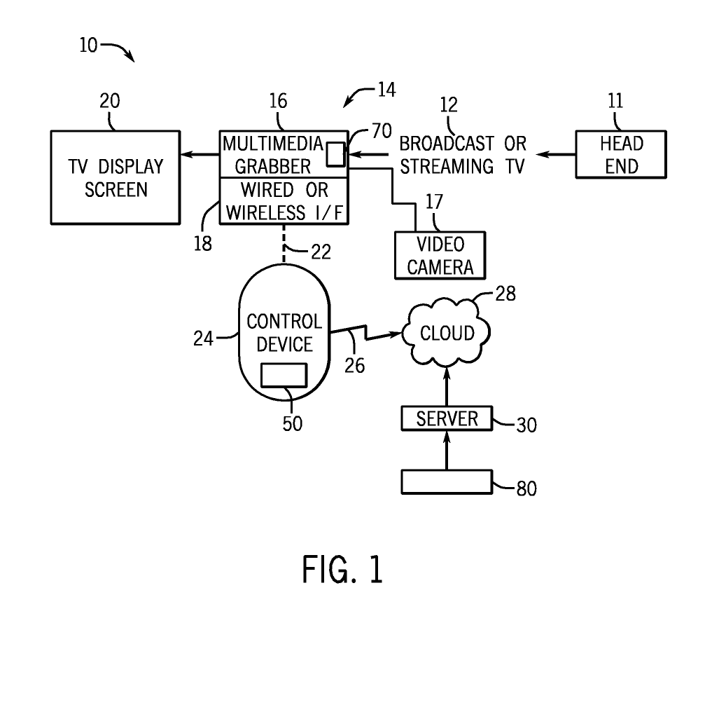

Referring to FIG. 1, a display screen 20, such as a television screen or monitor, may be coupled to a processor-based system 14, in turn, coupled to a video source, such as a television transmission 12 including a digital movie or a video game. This source may be distributed over the Internet or over the airwaves, including radio frequency broadcast of analog or digital signals, cable distribution, or satellite distribution or may originate from a storage device, such as a DVD player. The processor-based system 14 may be a standalone device separate from the video player (e.g., television receiver) or may be integrated within the video player. It may, for example, include the components of a conventional set top box and may, in some embodiments, be responsible for decoding received television transmissions.

In one embodiment, the processor-based system 14 includes a multimedia grabber 16 that grabs an electronic representation of a video frame or clip (i.e. a series of frames), metadata or sound from the decoded television transmission currently tuned to by a receiver (that may be part of the system 14 in one embodiment). The processor-based system 14 may also include a wired or wireless interface 18 which allows the multimedia that has been grabbed to be transmitted to an external control device 24. This transmission may be over a wired connection, such as a Universal Serial Bus (USB) connection, widely available in television receivers and set top boxes, or over any available wireless transmission medium, including those using radio frequency signals and those using light signals. The metadata may be metadata about the content itself (e.g., rating information, plot, director name, year of release).

In one embodiment, non-decoded or raw electronic representation of video clips may be transferred to the control device 24. The video clips may be decoded locally at the control device 24 or remotely, for example, at a server 30.

Also coupled to the system 14 and/or the display 20 may be a video camera 17 to capture images of the viewer for detecting user gestural commands, such as hand gestures. A gestural command is any movement recognized, via image analysis, as a computer input.

The control device 24 may be a mobile device, including a cellular telephone, a laptop computer, a tablet computer, a mobile Internet device, or a remote control for a television receiver, to mention a few examples. The device 24 may also be non-mobile, such as a desk top computer or entertainment system. The device 24 and the system 14 may be part of a wireless home network in one embodiment. Generally, the device 24 has its own separate display so that it can display information independently of the television display screen. In embodiments where the device 24 does not include its own display, a display may be overlaid on the television display, for example, by a picture-in-picture display.

The control device 24, in one embodiment, may communicate with a cloud 28. In the case where the device 24 is a cellular telephone, for example, it may communicate with the cloud by cellular telephone signals 26, ultimately conveyed over the Internet. In other cases, the device 24 may communicate through hard wired connections, such as network connections, to the Internet. As still another example, the device 24 may communicate over a television transport medium. For example, in the case of a cable system, a device 24 may provide signals through the cable system to the cable head end or server 11. Of course, in some embodiments, this may consume some of the available transmission bandwidth. In some embodiments, the device 24 may not be a mobile device and may even be part of the processor-based system 14.

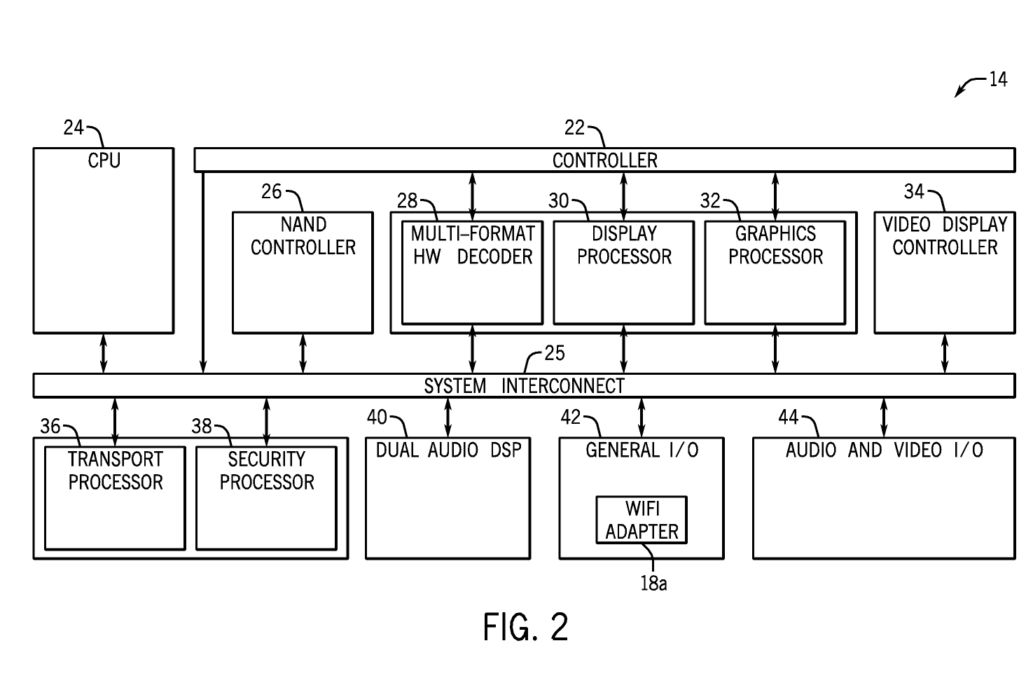

Referring to FIG. 2, one embodiment of the processor-based system 14 is depicted, but many other architectures may be used as well. The architecture depicted in FIG. 2 corresponds to the CE4100 platform, available from Intel Corporation. It includes a central processing unit 24, coupled to a system interconnect 25. The system interconnect is coupled to a NAND controller 26, a multi-format hardware decoder 28, a display processor 30, a graphics processor 32, and a video display controller 34. The decoder 28 and processors 30 and 32 may be coupled to a controller 22, in one embodiment.

The system interconnect may be coupled to transport processor 36, security processor 38, and a dual audio digital signal processor (DSP) 40. The digital signal processor 40 may be responsible for decoding the incoming video transmission. A general input/output (I/O) module 42 may, for example, be coupled to a wireless adaptor, such as a WiFi adaptor 18a. This will allow it to send signals to a wireless control device 24 (FIG. 1), in some embodiments. Also coupled to the system interconnect 25 is an audio and video input/output device 44. This may provide decoding video output and may be used to output video frames or clip in some embodiments.

In some embodiments, the processor-based system 14 may be programmed to output multimedia clips upon the satisfaction of a particular criteria. One such criteria is the detection of a user hand gesture. User hand gestures may be recorded by the camera 17 (FIG. 1) and analyzed using video analysis to recognize user inputs, such as commands to switch displays (e.g., flat hand), user likes (e.g., thumbs up) or dislikes (e.g., thumbs down). The video analyzing may be conducted by a television, including the system 14, control device 24 (FIG. 1), at the server 30 (FIG. 1), head end 11 (FIG. 1), or any combination thereof, such as in the television and the control device 24 (FIG. 1). A list of the user's likes or dislikes may be stored in any of those devices as well.

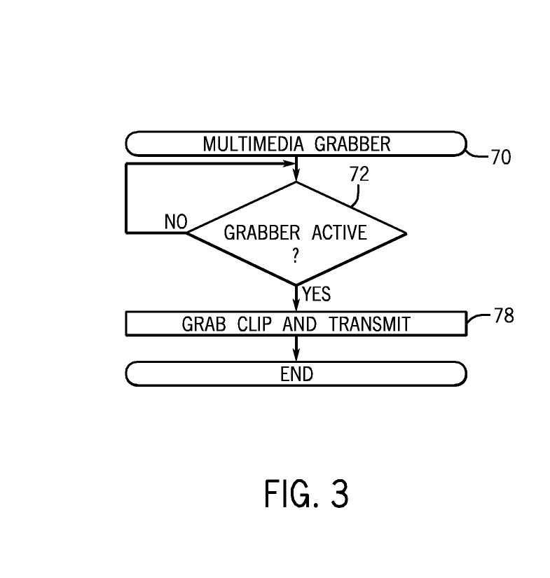

Referring to FIG. 3, a sequence may be implemented within the processor-based system 14. Again, the sequence may be implemented in firmware, hardware, and/or software. In software or firmware embodiments, it may be implemented by non-transitory computer readable media. For example, instructions to implement the sequence may be stored in a storage 70 (FIG. 1) on the system 14.

Initially, a check at diamond 72 determines whether the grabber feature has been activated. The grabber device 16 (FIG. 1) is activated to send a multimedia clip to the control device 24 (FIG. 1) when the system 14 (or some other device) detects a user hand gesture, in one embodiment. The hand gesture may be recorded by the video camera 17. Electronic video analysis may be used to detect a hand gesture, indicating that a multimedia clip should be captured and sent to the control device 24. Once transferred, a transferred video clip may appear on the display of the control device 24. Then, a multimedia clip is grabbed and transmitted to the control device 24 at block 78.

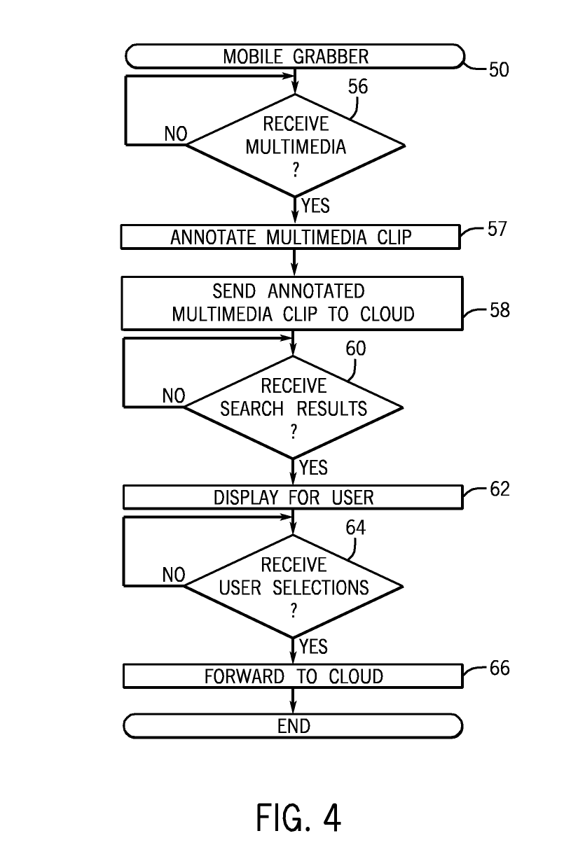

FIG. 4 shows a sequence for an embodiment of the control device 24 (FIG. 1). The sequence may be implemented in software, hardware, and/or firmware. In software or firmware based embodiments, the sequence may be implemented by computer executable instructions stored in one or more non-transitory computer readable media, such as an optical, magnetic, or semiconductor storage device. For example, the software or firmware sequence may be stored in storage 50 on the control device 24 (FIG. 1).

While an embodiment is depicted in FIG. 1 in which the control device 24 is a mobile device, non-mobile embodiments are also contemplated. For example, the control device 24 may be integrated within the system 14.

When the control device 24 receives a multimedia clip from the system 14, as detected at diamond 56, in some embodiments, the control device 24 may send the annotated multimedia clip to the cloud 28 for analysis (block 58). Then the device 24 may display a user interface to aid the user in annotating the captured clip (block 57) now displayed on the device 24.

In some embodiments, the user may append annotations to focus the analysis of the clip, as indicated in block 57. An annotation may also include questions about the clip for distribution as an annotation with the clip over social networking tools. For example, a text block may be automatically displayed over the transferred video clip on the control device 24. The user can then insert text that may be used as keywords for Internet or database searches. Also, the user may select particular depicted objects for providing search focus. For example, if two people appear in the clip, one of them may be indicated. Then, in the text box, the user may enter “Who is this actress?”. The search is then focused on identifying the indicated person.

The person in the clip can be selected using a mouse cursor or a touch screen. Also, video analysis of the user's finger pointing at the screen may be used to identify the user's focus. Similarly, eye gaze detection can be used in the same way.

Of course, the multimedia clip can be sent over a network to any server for image searching and/or analysis in other embodiments. The multimedia clip can also be sent to the head end 11 for image, text, or audio analysis, as another example.

If an electronic representation of audio is captured, the captured audio may be converted to text, for example, in the control device 24, the system 14 or the cloud 28. Then the text can be searched to identify the television program.

Similarly, metadata may be analyzed to identify information to use in a text search to identify the program. In some embodiments, more than one of audio, metadata, video frames or clips, may be used as input for keyword Internet or database searches.

A transferred video clip may also be distributed to friends using social networking tools. Those friends may also provide input about the video clip, for example, answering questions, accompanying the clip as annotations, like, “Who is this actress?”.

An analysis engine then may perform a multimedia search to identify the television transmission being viewed or to obtain other information about the clip, including scene or actor/actress identification or program identification, as examples. This search may be a simple Internet or database search or it may be a more focused search.

For example, the transmission in block 58 may include the current time or video capture and location of the control device 24. This information may be used to focus the search using information about what programs are being broadcast or transmitted at particular times and in particular locations. For example, a database may be provided on a website that correlates television programs available in different locations at different times and this database may be image searched to find an image that matches a captured frame to identify the program.

The identification of the program may be done by using a visual or image search tool. The image frame or clip is matched to existing frames or clips within the image search database. In some cases, a series of matches may be identified in a search and, in such case, those matches may be sent back to the control device 24. When a check at diamond 60 determines that the search results have been received by the control device 24, the search results may be displayed for the user, as indicated at block 62. The control device 24 then receives the user selection of one of the search results that conforms to the information the user wanted, such as the correct program being viewed. Then, once the user selection has been received, as indicated in diamond 64, the selected search result may then forwarded to the cloud, as indicated in block 66. This allows the television program identification or other query to be used to provide other services for the viewer or for third parties.

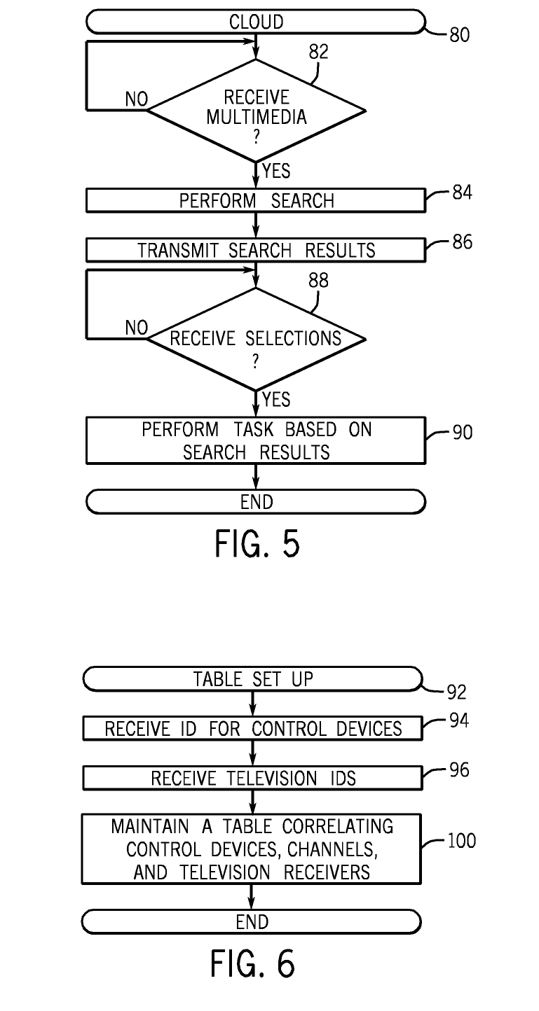

Referring to FIG. 5, an operation of the cloud 28 (FIG. 1) or other searching entity is indicated by the depicted sequence. The sequence may be implemented in software, firmware, and/or hardware. In software and firmware based embodiments, it may be implemented by non-transitory computer executed instructions. For example, the computer executed instructions can be stored in a storage 80, associated with the server 30, shown in FIG. 1.

While an embodiment using a cloud is illustrated, of course, the same sequence could be implemented by any server, coupled over any suitable network, by the control device 24 itself, by the processor-based device 14, or by the head end 11 in other embodiments.

Initially, a check at diamond 82 of FIG. 5 determines whether the multimedia clip has been received. If so, a visual search is performed, in the case where the multimedia is a video frame or clip, as indicated in block 84. In the case of an audio clip, the audio may be converted to text and searched. If the multimedia segment is metadata, the metadata may be parsed for searchable content. Then, in block 86, the search results are transmitted back to the control device 24, for example. The control device 24 may receive a user input or selection about which of the search results is most relevant. The system waits for the selection from the user and, when the selection is received, as determined in diamond 88, a task may be performed based on the television program being watched (block 90).

For example, the task may be to provide information to a pre-selected group of friends for social networking purposes. For example, the user's friends on Facebook may automatically be sent a message indicating which program the user is watching at the current time. Those friends can then interact over Facebook with the viewer to chat about the television program using the control device 24, for example.

As other examples, the task may be to analyze demographic information about viewers and to provide head ends or advertisers information about the programs being watched by different users at different times. Still other alternatives include providing focused content to viewers watching particular programs. For example, the viewers may be provided information about similar programs coming up next. The viewers may be offered advertising information focused on what the viewer is currently watching. For example, if the ongoing television program highlights a particular automobile, the automobile manufacturer may provide additional advertising to provide viewers with more information about that vehicle that is currently being shown in the program. This information could be displayed as an overlay, in some cases, on the television screen, but may be advantageously displayed on a separate display associated with the control device 24, for example. In the case where the broadcast is an interactive game, information about the game progress can be transmitted to the user's social networking group. Similarly, advertising may be used and demographics may be collected in the same way.

In some embodiments, a plurality of users may be watching the same television program. In some households, a number of televisions may be available. Thus, many different users may wish to use the services described herein at the same time. To this end, the processor-based system 14 may maintain a table which identifies identifiers for the control devices 24, a television identifier and program information. This may allow users to move from room to room and still continue to receive the services described herein, with the processor-based system 14 simply adapting to different televisions, all of which receive their signal downstream of the processor-based 14, in such an embodiment.

In some embodiments, the table may be stored in the processor-based system 14 or may be uploaded to the head end 11 or, perhaps, even may be uploaded through the control device 24 to the cloud 28.

Thus, referring to FIG. 6, in some embodiments, a sequence 92 may be used to maintain a table to correlate control devices 24 (FIG. 1), television display screens 20 (FIG. 1), and channels being selected. Then a number of different users can use the system through the same television, or at least two or more televisions that are all connected through the same processor-based system 14, for example, in a home entertainment network. The sequence may be implemented as hardware, software, and/or firmware. In software and firmware embodiments, the sequence may be implemented using computer readable instructions stored on at least one non-transitory computer readable media, such as a magnetic, semiconductor, or optical storage. In one embodiment, the storage 50 may be used (FIG. 1).

Initially, the system receives and stores an identifier for each of the control devices that provides commands to the system 14, as indicated in block 94. Then, the various televisions that are coupled through the system 14 may be identified and logged, as indicated in block 96. Finally, a table is setup that correlates control devices, channels, and television receivers (block 100). This allows multiple televisions to be used that are connected to the same control device in a seamless way so that viewers can move from room to room and continue to receive the services described herein. In addition, a number of viewers can view the same television and each can independently receive the services described herein.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
detecting a user gesture;
in response to detecting the gesture, automatically capturing a multimedia clip; and
using said clip to obtain more information about the clip.

2. The method of claim 1 including capturing an electronic clip representing a video frame or clip, audio or metadata.

3. The method of claim 1 including automatically transferring said clip to a mobile device.

4. The method of claim 3 including providing search results related to said clip to said mobile device.

5. The method of claim 3 including sending said clip to a remote server to perform said search.

6. The method of claim 1 including tracking a plurality of mobile devices, receiving requests from each of said devices, and providing responses to each device.

7. The method of claim 6 including maintaining a table correlating mobile devices and televisions and requests from mobile devices.

8. The method of claim 1 including automatically distributing said clip using a social networking tool.

9. The method of claim 1 including automatically capturing a decoded television clip.

10. The method of claim 9 including automatically transferring the clip to a mobile device, displaying the clip on the mobile device, and enabling a user to annotate the clip on the mobile device.

11. At least one non-transitory computer readable medium storing instructions to enable a computer to:
detect a user gestural command;
in response to detection of the command, capture an electronic decoded signal from a television program; and
initiate a search using said signal to facilitate identification of the television program.

12. The medium of claim 11 further storing instructions to capture an electronic decoded signal in the form of a video frame or clip, audio or metadata.

13. The medium of claim 11 further storing instructions to transfer said signal to a mobile device.

14. The medium of claim 13 further storing instructions to provide search results to said mobile device.

15. The medium of claim 13 further storing instructions to send said signal to a remote server to perform said search.

16. The medium of claim 11 further storing instructions to distribute said identification using a social networking tool.

17. The medium of claim 11 further storing instructions to display the clip on a mobile device.

18. The medium of claim 17 further storing instructions to enable the user to annotate the clip.

19. The medium of claim 18 further storing instructions to automatically overlay a text entry box overlying a display of the clip on the mobile device.

20. The medium of claim 19 further storing instructions to enable a user to select an item depicted in said clip.

21. The medium of claim 11 further storing instructions to capture a gestural command to change the display from one device to another.

22. The medium of claim 11 further storing instructions to associate gestural commands with currently displayed content.

23. The medium of claim 22 further storing instructions to recognize gestural commands indicating whether the user likes currently displayed content.

24. An apparatus comprising:
a processor to detect hand gestures, automatically capture an electronic signal from a video in response to detection of a hand gesture, and transmit said signal for display on a mobile device; and
a storage coupled to said processor.

25. The apparatus of claim 24 wherein said apparatus is a television receiver.

26. The apparatus of claim 24 wherein said apparatus to signal a television receiving system to capture an electronic decoded signal in the form of a video frame or clip, audio or metadata.

27. The apparatus of claim 24 wherein said apparatus to receive said signal from a television system and to transmit said signal to a remote device to perform a keyword search in a database or over the Internet.

28. The apparatus of claim 27, said apparatus to automatically distribute said clip over a social networking tool.

29. The apparatus of claim 28 wherein said apparatus is a set top box.

30. The apparatus of claim 24 wherein said apparatus includes a television and/or a mobile device.
